(19) United States
(12) Patent Application Publication
(10) Pub. No.: US 2026/0217076 A1
(43) Pub. Date: Jul. 30, 2026

(54) MOBILE ROBOT SUSPENSION SYSTEM

(71) Applicant: Difacto Robotics & Automation Private Ltd., Bengaluru (IN)

(72) Inventors: Praveen S., Bengaluru (IN); Aditya M.R., Bengaluru (IN)

(21) Appl. No.: 19/118,573

(22) PCT Filed: Oct. 5, 2023
(86) PCT No.: PCT/IB2023/060000

§ 371 Date: Apr. 4, 2025

(30) Foreign Application Priority Data
Oct. 6, 2022 (IN) 202241057089

(51) Int. Cl. B60G 17/016; B60G 17/015

(52) U.S. Cl. CPC B60G 17/016; B60G 17/0152

(57) ABSTRACT

This invention presents a comprehensive solution for enhancing the performance and adaptability of mobile robots through an innovative suspension system. Leveraging readily available industry-standard components, this system prioritizes continuous floor contact, even on uneven terrain, improving stability under varying speed and load conditions. A pivotal feature is the incorporation of the Parallel Guided Spring's Assembly, effectively addressing vibrations during robot travel. This assembly allows compression and extension movements, reducing vibration amplitudes and enhancing the linear relationship between the robot and the floor. Moreover, this system maintains essential tractional force, reducing motor torque requirements, optimizing energy efficiency, and prolonging motor life. Its modular and compact design streamlines maintenance, ensuring swift component replacements. These embodiments collectively offer a holistic solution for mobile robots, addressing functionality, user experience, and maintenance efficiency, all while utilizing readily available industry-standard components.

### CROSS-REFERENCE TO RELATED APPLICATIONS AND PRIORITY

The present application claims priority from Indian provisional patent application No. 202241057089.

### FIELD OF THE INVENTION

The invention relates generally to the technical field of robot technology. More specifically, the invention relates to a suspension system used for mobile robots that operate at factories, homes, hospitals, laboratories and offices within in-door and out-door facilities.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of Mobile robots being mechanical devices that perform a work automatically.

One of the critical challenges facing mobile robots, especially those used in industrial environments, is their ability to navigate effectively and safely across various surfaces. In many cases, these surfaces are uneven, which can lead to issues related to vibration, shaking, and stability. These challenges are particularly significant in industrial settings where precise movement and stability are crucial for both safety and efficiency reasons. The existing problem that the invention aims to address is the limited ability of many mobile robots to operate smoothly and stably on uneven surfaces. Some mobile robots currently available in the market lack the necessary suspension systems to counteract the effects of vibrations and shaking caused by uneven floors. This limitation can result in reduced efficiency, increased wear and tear on the robot's components, and even safety concerns.

In industrial environments, where mobile robots are often tasked with carrying out critical operations, ensuring their stability and continuous contact with the floor is essential. Without a reliable suspension system, these robots may struggle to maintain traction, which can lead to slippage, loss of control, and potential damage to the robot or the objects it's handling.

To address these limitations, the subject invention proposes a novel suspension system specifically designed for mobile robots. This suspension system is intended to provide anti-vibration and anti-shake capabilities, making it possible for mobile robots to operate effectively on uneven surfaces. Importantly, the invention achieves this using standard equipment readily available in the industry, ensuring that the solution can be easily implemented and integrated into existing mobile robot designs.

The subject invention overcomes the limitations of the prior art by proposing a mobile robot suspension system, which can realize the anti-vibration and anti-shake functions of the mobile robot. The disclosed suspension system is built with standard equipment available across the industry and assists the mobile robots to have continuous contact with the floor to drive through uneven floor areas.

Overall, the subject invention aims to revolutionize the role of mobile robots in various applications and the specific challenges they face when operating on uneven surfaces. The invention's primary goal is to overcome these limitations by introducing a suspension system that enhances the stability, traction, and overall performance of mobile robots, ultimately making them more effective and reliable tools for a wide range of tasks in both indoor and outdoor settings.

### SUMMARY OF INVENTION

In one or more embodiments of this invention, the primary aim is to develop a suspension system that facilitates continuous ground contact for mobile robots, enabling them to traverse uneven terrain seamlessly. Additional features and advantages of embodiments of the present invention will be set forth in the description which follows, and in part will be apparent from the description, or may be learned by practice of embodiments of the present disclosure. The objectives and other advantages of the embodiments of the present disclosure may be realized and attained by the structure particularly pointed out in the written description and claims hereof as well as the appended drawings.

The present invention provides a suspension system constructed from readily available industry-standard components. This innovative system serves the dual purpose of ensuring that the mobile robots maintain uninterrupted contact with the floor, even on uneven surfaces, while enhancing their stability during varying speed and load conditions. The invention comprises:
a) A suspension system designed to facilitate continuous floor contact, enabling mobile robots to navigate uneven terrain effectively. This system leverages industry-standard components for seamless implementation.
b) A system is designed to effectively address jounces (upward movements) and rebounds (downward movements) encountered during robot travel. This is achieved through the innovative incorporation of a Parallel Guided Spring's Assembly, enabling both compression and extension movements in a vertically oriented plane that is perpendicular to the longitudinal axis of the Mobile Robot's chassis. This unique assembly significantly reduces the amplitude of vibrations experienced by the Mobile Robot during its movement, resulting in an enhanced linear relationship between the Mobile Robot and the floor it traverses. This innovative approach optimizes stability, control, and overall performance.
c) The suspension system also incorporates features to bolster drive stability in mobile robots, particularly when subjected to dynamic speed and load variations. This ensures consistent and reliable performance under various operational conditions.
d) Furthermore, the suspension system includes mechanisms to maintain the required tractional force against the floor, optimizing the driving torque requirement of the motor unit. This innovation leverages readily available industry-standard equipment, making it both cost-effective and versatile for a wide range of mobile robot applications.

Specifically, the embodiments of the invention focus on the primary objective of the invention which is to provide a tailored solution for suspension systems using readily available standard equipment from the industry. This means that the invention seeks to create an innovative suspension system without requiring the development of entirely new or specialized components. The system is cost-effective and easier to implement in various mobile robot applications.

An embodiment of the invention is to provide mobile robots equipped with the aforementioned suspension system to maintain continuous contact with the floor, even on uneven surfaces. This is critical for stability and control, allowing the robot to navigate rough terrain or uneven floors without losing traction or stability.

Another embodiment of the invention is enhancement of drive stability in mobile robots. The primary objective is to improve the robot's ability to maintain stability while operating at dynamic speeds and under varying load conditions. This aspect is crucial for several reasons:

Drive stability plays a pivotal role in preventing accidents during robot operation. As mobile robots navigate through different environments and scenarios, unexpected obstacles or changes in terrain can lead to accidents. By bolstering drive stability, the robot can better respond to these challenges, reducing the risk of collisions and mishaps.

Precision is another key benefit of this embodiment. In applications where precise movements and control are essential, such as in manufacturing or medical environments, any deviation from the intended path or action can have detrimental consequences. Improved drive stability ensures that the robot can execute tasks with a high degree of accuracy, contributing to consistent and reliable performance.

Furthermore, achieving stability is essential for optimizing the robot's overall performance, especially in demanding environments. Mobile robots are increasingly used in industries where they encounter varying loads or need to operate at varying speeds. These conditions can exert significant stress on the robot's components and systems. By enhancing drive stability, the robot can maintain its effectiveness and efficiency under these challenging circumstances, extending its operational capabilities.

In summary, this embodiment addresses the critical need for improved drive stability in mobile robots, particularly when they face dynamic speed changes and varying load conditions. This enhancement has far-reaching implications, from accident prevention to precision and overall performance optimization, making it a vital component of the invention's innovative features.

In another embodiment of the invention the focus lies on the creation of an advanced Suspension System designed to cater to the nuanced challenges of mobile robot operation, which is the deployment of a Parallel Guided Spring's Assembly, a sophisticated engineering solution that addresses the crucial issues of jounces (upward movements) and rebounds (downward movements) experienced by mobile robots during travel as depicted is FIG. 1. The Parallel Guided Spring's Assembly is designed to execute both compression and extension movements within a vertically oriented plane, which runs perpendicular to the longitudinal axis of the Mobile Robot's chassis. The unique assembly serves as an ingenious shock-absorbing mechanism, significantly reducing the magnitude of vibrations encountered by Mobile Robots during their operational journeys.

The embodiment of this invention is the substantial enhancement of the linear relationship between the Mobile Robot and the floor it traverses. By mitigating vibrations and disturbances, the Mobile Robot can maintain uninterrupted contact with the floor, even when navigating uneven terrain or subjected to dynamic changes in speed and load. This improved linear relationship translates into heightened stability, precise control, and optimal overall performance.

In summary, this embodiment of the invention places emphasis on the development of a Suspension System equipped with a Parallel Guided Spring's Assembly. This assembly is instrumental in addressing jounces and rebounds encountered during robot travel, effectively reducing vibrations and elevating the Mobile Robot's linear relation to the floor.

Another embodiment of the invention provides a vital function of maintaining the necessary tractional force between the robot and the flooring surface. By ensuring this tractional force, the invention achieves several significant benefits by maintaining the required tractional force which is instrumental in reducing the driving torque requirements of the robot's motor unit. This reduction in torque demands not only enhances the robot's energy efficiency but also extends the operational life of the motor unit. The reduction in driving torque requirements leads to energy savings, which can be particularly advantageous in mobile robot applications where battery life or energy efficiency is a critical consideration. By optimizing the tractional force, the invention contributes to prolonged operational periods and reduced power consumption, ultimately improving the overall cost-effectiveness and sustainability of the robot.

Moreover, this embodiment plays a pivotal role in ensuring the robot's stability and control during its movements on various floor surfaces. Whether the robot is navigating smooth floors or uneven terrain, maintaining the necessary tractional force enables it to maintain its course, preventing slippage or loss of control. This aspect is crucial for safety and precise manoeuvring, especially in dynamic and demanding environments.

In summary, this embodiment focuses on maintaining the essential tractional force between the robot and the flooring, which results in reduced motor torque requirements, energy savings, extended motor life, enhanced stability, and precise control. These advantages collectively contribute to the overall effectiveness and efficiency of the mobile robot, making it a valuable component of the invention's innovative features.

Another embodiment of the invention provides a mounting of the Suspension Unit to the Mobile Robot which is a critical aspect of the present invention, and it is carried out with precision to ensure optimal performance and reliability.

In summary, the mounting of the Suspension Unit to the Mobile Robot is a critical aspect of this embodiment of the invention. It involves securing the Drive Wheel Assembly, utilizing mounting brackets for top mounting, ensuring proper alignment for consistent floor contact, providing structural support, isolating vibrations, and handling impact loads. This integration enhances the overall performance and reliability of the Mobile Robot, making it well-suited for demanding industrial environments.

Another embodiment of the invention, focuses on the suspension system's design, emphasizing modularity and compactness. The embodiment of the invention is to streamline maintenance tasks, making them more efficient and less time-consuming. The modular and compact design brings several advantages:

The modularity of the suspension system design enables the replacement or upgrading of individual components without necessitating a complete overhaul of the entire system. This approach significantly reduces downtime during maintenance, ensuring that the robot can return to operation swiftly. It enhances the overall efficiency of maintenance procedures and minimizes disruption to the robot's tasks.

Additionally, the compact design not only conserves space but also simplifies the physical accessibility of components within the suspension system. This ease of access further facilitates maintenance procedures. Technicians can quickly identify and address issues, contributing to faster resolution times and minimizing service costs.

Furthermore, the modular and compact design aligns with the broader goals of cost-effectiveness and sustainability. By minimizing the need for extensive maintenance and component replacements, the invention reduces both operational expenses and waste. It also prolongs the service life of the suspension system, ensuring that it remains in optimal working condition for an extended period.

In summary, this embodiment focuses on creating a suspension system with a modular and compact design, which simplifies maintenance tasks, reduces downtime, enhances accessibility, and aligns with cost-effective and sustainable practices. These advantages collectively contribute to the overall efficiency and longevity of the mobile robot, reinforcing its value as a key aspect of the invention.

Overall, the embodiments of the present invention described above provides a multifaceted solution for enhancing the capabilities and efficiency of mobile robots through the development of a customized suspension system, utilizing readily available industry-standard components. This innovative suspension system serves a dual purpose: firstly, enabling mobile robots to maintain uninterrupted contact with the floor, even on uneven surfaces, enhancing their stability during dynamic speed changes and varying load conditions, ultimately leading to improved safety, precision, and overall performance in demanding environments; secondly, the invention prioritizes modularity and compactness in the suspension system's design, streamlining maintenance tasks and minimizing downtime by allowing for individual component replacement or upgrades, thus contributing to efficient maintenance practices and sustainability. Additionally, by maintaining the required tractional force between the robot and the flooring, the invention reduces motor torque requirements, resulting in energy savings and extended motor life, further enhancing cost-effectiveness and environmental sustainability. In combination, these embodiments collectively represent a comprehensive innovation tailored to meet the diverse needs of mobile robot applications, offering a holistic solution that addresses functionality, user experience, and maintenance efficiency while utilizing readily available industry-standard components.

It is to be understood that both the foregoing general description and the following detailed description are exemplary and explanatory and are intended to provide further explanation of embodiments of the invention as claimed.

### BRIEF DESCRIPTION OF THE DRAWINGS

The drawings illustrate the design and utility of various embodiments of the invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which references have been made to a system, depicted in FIGS. 1 to 7 herein without limitation, to describe the invention which is essentially directed towards providing the user with the option to assist Mobile Robots to have continuous contact with the floor—with the aid of Unsprung-Weight.

The Suspension System will address jounces and rebound while in travel by Parallel Guided Spring's Assembly (compression and extension in a vertically oriented plane perpendicular to the longitudinal axis of Mobile Robots chassis) which significantly reduces vibration of Mobile Robots-Thereby improving the linear relation between Mobile Robot and the floor.

FIG. 1 shows the functional schematic view of the suspension unit.

FIGS. 2 and 3 describes the different phases of the suspension system drive wheel contacting the floor.

FIG. 4 gives the split view of the suspension unit.

FIG. 5 describes the mounting of the suspension unit to the mobile robot.

FIG. 6 gives a schematic view of the functional units that comprise the system.

FIG. 7 describes the components of the system and their connection with each other.

### COMPONENTS OF THE INVENTION

The subject invention comprises the following:

### Essential/Basic Functional Units

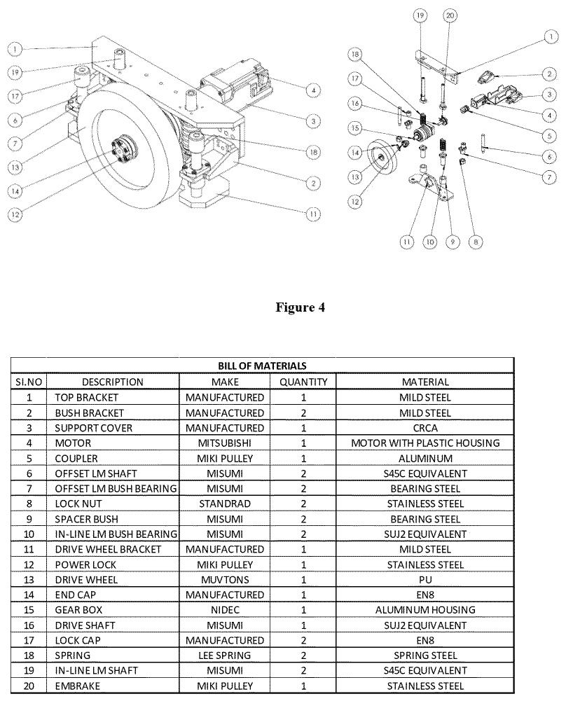

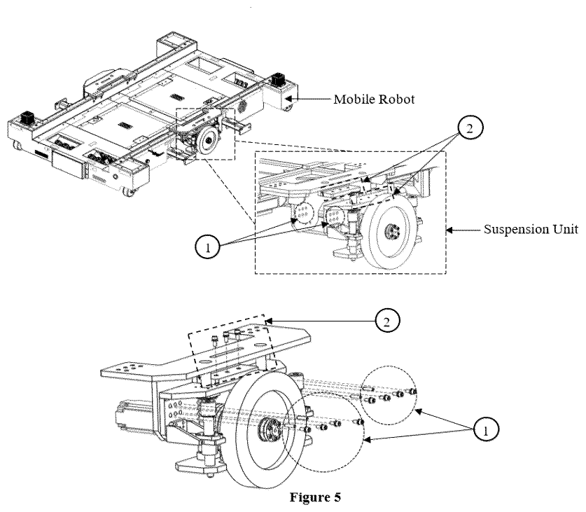

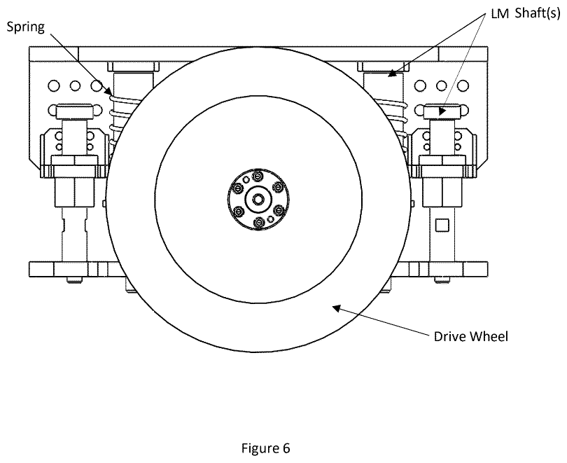

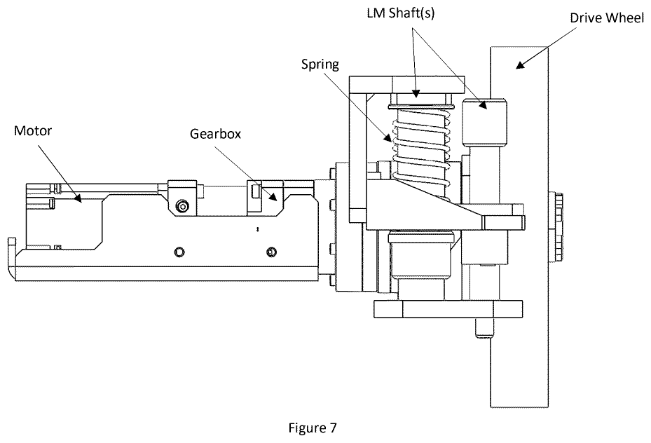

### As Depicted in FIG. 4

1. Mounting Brackets and Resting Blocks: It is the prime and supporting component of the Suspension unit that will house all the equipment in place.
2. Offset LM Shaft: This is defined to Carry the Load and as additional support for Wheel Alignment.
3. Offset LM Bush Bearing: This is defined to Guide and support Offset LM shafts.
4. In-Line LM Shaft: This is defined to Carry the Load, Guide Spring Assembly and as additional support for Wheel Alignment.
5. In-Line LM Bush Bearing: This is defined to Guide and support In-Line LM shafts.
6. Compression Springs: Assists in achieving suspension and traction at the Drive Wheel

### Accessories

7. Drive Wheel—Polyurethane-based center mount castor wheel for mobile robot movement.
8. Mechanical Shaft Locks: These are mechanical shaft locks that use tapers. The wedging action of the tapered surface when the clamping bolt is locked thoroughly couples the shaft and hub.
9. Gear Box: The reducer-type gear assembly to achieve desired driving torque.
10. Electrical Motor: To achieve driving movement for the mobile robot—Position and displace the mobile robot within the workspace.

### Mobile Robot-Suspension System:

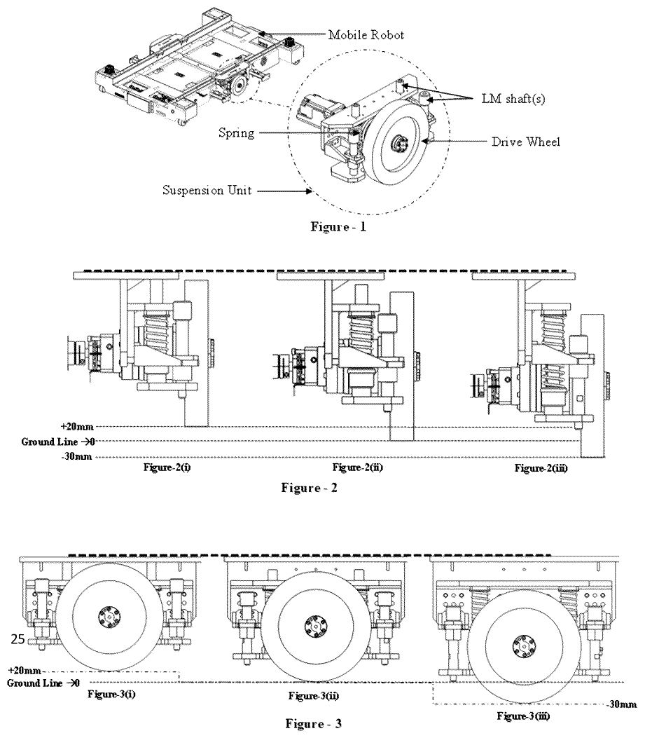

As shown in FIG. 2, the suspension unit is connected to Mobile Robots to have continuous contact with the floor while driving and to address floor irregularity as shown in FIGS. 2(i), 3(i), 2(iii) and 3(iii). As shown in FIGS. 2(ii) and 3(ii), the Suspension System Drive wheel will be contacting the floor, at this condition, the spring will be compressed up to 50 mm. As shown in FIGS. 2(i) and 3(i), the Suspension System Drive wheel will be contacting the floor which is 20 mm higher or elevated from the ground level, at this condition, the spring will be compressed up to 70 mm. As shown in FIGS. 2(iii) and 3(iii), the Suspension System Drive wheel will be contacting the floor, which is 30 mm lower than the ground level, at this condition, the spring will be compressed up to 20 mm. As shown in FIG. 4, the In-line LM shaft (6) is connected to the drive wheel bracket (11) followed by the spacer bush (9), spring (18), and In-line bush bearing (10) are placed to the In-line LM shaft (6) and the In-line LM bush bearing (10) will be connected the top bracket (1). Offset LM bush bearing (7) is connected to bush bracket (2) and it will be connected to top bracket (1). Offset shaft (6) is inserted to offset LM bush bearing (7) and connected to drive wheel bracket (11) and bolted with lock nut (8) and lock cap is bolted to offset LM shaft (6). Gearbox (15) is connected to EM brake (20) via Driveshaft (16) and Driveshaft (16) is connected to Coupler (5) through which motor (4) is connected to the Gear Box (15) and this entire setup is connected from gearbox (15) to drive wheel bracket (11). The drive wheel (13) is connected to Gearbox (15) via power lock (12) and enclosed with an end cap (14).

### Suspension Unit Mounting to Mobile Robot

1. Drive wheel assembly is mounted to the Mobile Robot main body with bolts and dowels on both sides respectively.
2. From the top it is mounted to the assembly through mounting brackets

Modern-day mobile robots when considered to operate especially in an industrial environment, they are intended to have consistent performance across the varying and challenging path they move through while serving a process need. The suspension units are the key components of mobile robots in order to achieve process quality. The suspension units in operation will exhibit a continuous contact of drive wheels to the floor, maintain the required traction force and increases the mobile robot's dynamic stability for varying speed and load conditions. The suspension system increases the mobile robot drive stability under dynamic speed and load conditions and maintains the required tractional force against flooring, thereby optimizing the driving torque requirement of the motor unit. In addition, the system is modular and has a compact design to ensure easy and quick maintenance.

The suspension unit is built with the principle of parallel guided spring assembly to achieve suspension action and consists of a drive wheel assembly, a compression spring internally guided by Linear-Motion (LM) Shaft and Bush Bearing, an Offset LM Shaft and Bush Bearing for load carrying and alignment and mounting brackets and resting blocks.

The suspension system is compact in design and comes with a minimal footprint. It is featured to function in both forward and backward directions of drive-wheel movement. The modular design of the system ensures quick interchangeability of equipment and ease of suspension system scalability. Since it is built with standard equipment, the system is easy to maintain with a minimal maintenance cost over the functional life. The LM Shaft and Bush Bearing ensure choke-free suspension movement, and the in-built manual wheel-jack option facilitates easy drive wheel replacement.

The Suspension System provides added advantages listed below,
1. Controlling and subduing the continuous vibration initiated due to floor irregularities thereby preventing the transfer of such vibration to the Mobile Robot Chassis.
2. Absorbing instantaneous loads that are encountered while traveling through the floor humps and potholes thereby preventing the transfer of such impact loads to the Mobile Robot Chassis.
   Incorporating the above-mentioned sophisticated Suspension Systems within the Mobile Robots increases motion efficiency and stability.

1. A suspension system for mobile robots, comprising:
a. A Drive Wheel Assembly securely mounted to the main body of the Mobile Robot, ensuring precise alignment;
b. Mounting brackets positioned strategically to distribute loads and enhance structural integrity;
c. Alignment mechanisms for maintaining consistent contact between the Drive Wheels and the floor surface;
d. Structural support for the Mobile Robot's chassis during dynamic movements and uneven terrain traversal; and
e. A Parallel Guided Spring's Assembly to dampen and prevent the transfer of disruptive forces by providing Vibration isolation capabilities.

2. The suspension system of claim 1, further comprising:
a. Linear-Motion (LM) Shaft and Bush Bearings for internally guiding compression springs, ensuring smooth suspension movement; and
b. An Offset LM Shaft and Bush Bearing designed for load carrying and alignment.

3. The suspension system of claim 1, wherein the Drive Wheel Assembly is equipped with a Polyurethane-based center mount castor wheel to facilitate the Mobile Robot's movement.

4. The suspension system of claim 1, further comprising a Gearbox and Electrical Motor to achieve the desired driving torque, positioning, and displacement of the Mobile Robot within its workspace.

5. The suspension system of claim 1, designed to function effectively in both forward and backward directions of drive-wheel movement.

6. The suspension system of claim 1, characterized by its minimal footprint to ensure it does not interfere with the Mobile Robot's maneuverability and workspace.

7. The suspension system of claim 1, which effectively controls and dampens continuous vibrations originating from floor irregularities, preventing their transfer to the Mobile Robot Chassis.

8. The suspension system of claim 1, designed to absorb and mitigate instantaneous loads encountered during travel over floor humps and potholes, thereby preserving the structural integrity of the Mobile Robot Chassis.

9. The suspension system of claim 1, enhancing motion efficiency and stability within Mobile Robots, making them well-suited for operation in demanding industrial environments.

10. The suspension system of claim 1, wherein the Parallel Guided Spring's Assembly includes shock absorbers, springs, and sensors for real-time monitoring and adjustment of suspension parameters, further enhancing the system's capability to address jounces and rebounds, significantly reducing vibrations, and improving the linear relationship between the Mobile Robot and the floor.

11. The suspension system of claim 1, further comprising an onboard control unit equipped with software algorithms that analyze data from the sensors within the Parallel Guided Spring's Assembly and adjust suspension parameters dynamically, enhancing the Mobile Robot's stability and performance based on real-time feedback.

12. A mobile robot equipped with the suspension system of claim 1, wherein the robot maintains continuous contact with the floor even on uneven surfaces, enhances stability during dynamic speed changes and varying load conditions, and achieves energy efficiency through reduced motor torque requirements.

13. A method for operating a robotic suspension system in mobile robots, comprising the steps of:
a) Facilitating continuous and uninterrupted contact between the mobile robot and the floor, allowing seamless navigation over uneven terrain and dynamic operational conditions through the deployment of a Parallel Guided Spring's Assembly;
b) Addressing jounces and rebounds during robot travel by enabling compression and extension movements in a vertically oriented plane, which is perpendicular to the longitudinal axis of the Mobile Robot's chassis, thereby significantly reducing vibrations experienced by the Mobile Robot;
c) Improving the linear relationship between the Mobile Robot and the floor, resulting in enhanced stability, control, and overall performance.

14. The method of claim 13, further comprising the step of monitoring suspension parameters in real-time using sensors integrated into the Parallel Guided Spring's Assembly, and adjusting said parameters dynamically to optimize the Mobile Robot's stability and control during operation.

15. The method of claim 13, further comprising the step of fine tuning the compression and extension movements of the Parallel Guided Spring's Assembly through an actuator mechanism, allowing the system to adapt to varying terrain conditions and speed changes for improved stability.

16. The method of claim 13, further comprising the step of detecting variations in floor conditions through a feedback mechanism and autonomously adjusting suspension parameters in response to detected changes, ensuring continuous and uninterrupted contact between the Mobile Robot and the floor.

17. The method of claim 13, further comprising the step of providing users with customizable settings to fine-tune the system's response to specific operational requirements, terrains, or load conditions, thus enhancing adaptability and flexibility.
